(19) United States
(12) Patent Application Publication
(10) Pub. No.: US 2023/0020260 A1
(43) Pub. Date: Jan. 19, 2023

(54) METHOD AND APPARATUS FOR MELTING GLASS

(71) Applicant: SCHOTT AG, Mainz (DE)

(72) Inventors: Volker OHMSTEDE, Bingen (DE); Michael HAHN, Hohenstein (DE); Günter WEIDMANN, Flonheim (DE); Hildegard RÖMER, Karben (DE); Peter FRANKE, Dreieich (DE); Frank-Thomas LENTES, Bingen (DE); Wolfgang SCHMIDBAUER, Mainz (DE); Rainer Erwin EICHHOLZ, Frankfurt am Main (DE)

(73) Assignee: SCHOTT AG, Mainz (DE)

(21) Appl. No.: 17/930,007

(22) Filed: Sep. 6, 2022

Related U.S. Application Data
(63) Continuation of application No. PCT/EP2021/051118, filed on Jan. 20, 2021.

(30) Foreign Application Priority Data
Mar. 5, 2020 (DE) 10 2020 106 051.3

(51) Int. Cl. C03B 5/02; C03B 5/03

(52) U.S. Cl. CPC C03B 5/023; C03B 5/03

(57) ABSTRACT

A method and an apparatus for melting down glass are provided. The method includes using microwave radiation for at least part of the energy supply for melting for transforming a batch into a glass melt. The microwave radiation captures at least part of the transition between batch and primary melt. The method and apparatus include melting assembly with a melting tank which has walls within which both the batch for melting and the molten batch can be accommodated as a glass melt, where above the batch and above the glass melt there is at least one microwave-emitting source disposed.

### CROSS REFERENCE TO RELATED APPLICATIONS

This application is a continuation of International Application PCT/EP2021/055518 filed Jan. 20, 2021, which claims the benefit under 35 USC § 119 of German Application 10 2020 106 051.3 filed Mar. 5, 2020, the entire contents of all of which are incorporated herein by reference.

### BACKGROUND

### 1. Field of the Invention

The invention relates to a method and to an apparatus for melting down glass, more particularly for transforming a batch into a glass melt, with using microwave radiation.

### 2. Related Art

Glass-melting tanks on the industrial scale are conventionally heated generally with burner technologies. Gas and/or oil are used for combustion in the corresponding burners, and hence CO₂ and, moreover, when air is used, NOx as well are released as offgas.

The technologies addressed in part of the prior art describe discontinuous crucible melting and address heating with microwaves.

WO 200200063 A describes a crucible in a microwave resonator. The microwave heating enables improved chemical homogeneity of the glass melt. The chemical homogeneity is attributable to hotspots (thermal inhomogeneities) in the volume of the melt.

In WO 199700119 A the melt is heated in a cooled cavity with an adjustable microwave radiation. The melt is housed in a “closed” skull, where a plasma burner is used or graphite is added in order to enable improved incoupling of the microwave radiation.

DE 19541133 describes the melting of phosphate glass in a microwave-heated crucible, but without giving details on the incoupling of the microwave radiation and the properties thereof.

Another part of the prior art implements continuous melting processes with ancillary microwave heating. These processes are described for example in the following specifications:

DE 200910025905 discloses a melting process which claims melting down of batch by means of thin-layer melting. The thin-layer melting module consists of a double-wall tube, which in one variant can be heated with microwave radiation from outside by way of a susceptor. The aim is to melt down low-melting eutectics and specific raw material preparations. The direct coupling of the microwave to the batch is not disclosed. The microwave radiation is coupled into a susceptor, which in turn heats the batch.

FR 19960005084 A describes an overflow crucible which is heated with microwave radiation. In a discharge crucible or a v- or u-shaped tube, a standing wave is generated within a tube. The microwave power is homogenized by modulation of the standing wave. The advantage is effective homogenization of the melt by virtue of a large-volume mixing effect.

DE 10 2016 205 845 A1 discloses microwave heating, among others, for a preliminary reaction of batch. A disadvantage however, is that in this temperature range specifically the microwave radiation is only absorbed to a very small extent by the batch and the heating power in this case is very inefficient.

JP 19800125514 describes a discharge crucible in a closed resonator into which microwave energy is coupled. This document as well does not mention focusing into the primary melt region; instead, the microwave energy is coupled into the molten glass, in which particulate constituents for melting are distributed.

DE 10 2016 200 697 A1 claims a continuously operated tank which can be heated by various methods—including microwave. Focusing onto the location of the microwave energy is not described.

CN 204224428 U discloses a gas-fired melting tank in which microwave radiation is coupled into a charging tube beneath the charge.

US 20140255417 describes a method for producing small glass portions in a continuous furnace. Microwave heating is claimed alongside diverse heating methods. The system here, however, does not involve a melting tank. The energy is coupled into compacts of raw material.

CN 203128388 U and CN 201210552723 describe a burner-heated glass-melting tank with microwave emitters in the dome, which are used for destroying foam. The second document also claims that the microwave has a heating function. There is, however, no pure microwave top heat. Nor is there is any description regarding releasable energy between batch and primary melt.

WO 2006 059576 A claims a microwave-assisted reduced-pressure refining chamber.

In US 2004056026 A cascade tank having multiple crucibles arranged in series is described, these crucibles being positioned in serially arranged microwave resonators, which are heated by means of microwave radiation.

The company Gyrotron Technology Inc. presents the topic of glass melting by means of microwave technology. The principal feature is the use of Gyrotrons in the frequency range from >30 GHz to more than 100 GHz. Gyrotrons are tubes for which the microwave generation efficiency in their use is low and the investment costs of such a system are very high. Magnetrons are the economic solution, but this solution is not available for the high frequencies.

These high frequencies (>30 GHz) are undesirable, as the penetration depth is extremely small and the risk of overheating is too high. With microwaves in the region around 2 GHz, conversely, the risk is much lower. The efficiency of high-power Gyrotrons is nowadays comparable with that of magnetrons, owing to numerous developments in the plasma physics/nuclear fusion sector.

In all cases known to date, the microwave acts on the total melt volume and there is essentially no directed heating. The critical factor is the power density (W/m³) dissipated in the melting material.

Furthermore, the throughput of all-electric tanks, which feature ohmic heating, is generally limited, since the power input per unit area of melt is limited by the maximum permissible current density at the electrodes. With certain glasses, the dependency relationship between the current density and the type of glass means that the ohmic heating is limited, with values<10% of the total energy requirement. Ohmic heating in the context of the present invention refers to heating wherein an electrical current passed through the melt generates heat at the ohmic resistance of the glass melt, this heat being introduced into the glass melt for heating.

### SUMMARY

The object on which the invention is based is that of developing existing melting methods and apparatuses such that a higher efficiency is achieved in the utilization of the heating energies used, and preferably of reducing the environmental burden of the melting-down of glass, particularly associated with the transformation of a batch into a glass melt.

This object is achieved with the method and apparatus disclosed herein.

In accordance with the invention, in a method for melting down glass, microwave radiation is used for at least a part of the energy supplied for melting for transforming a batch into a glass melt, with the microwave radiation used capturing at least a part of the transition between batch and primary melt.

The microwave radiation here couples into the upper region directly below the batch covering, and hence into the melting reaction zone, where it increases the temperature and accelerates melt production, especially in relation or in comparison to an otherwise identical method without the use of microwave radiation.

It is precisely in this vesicular primary melt region of the first liquid phases that a large part of the microwave energy is advantageously absorbed, as will be set out in more detail hereinafter.

The zone between the glass melt and the batch covering on the glass melt, which is also referred to as the batch carpet, is therefore preferably heated in a planar manner.

Coupling, or incoupling, refers in this context to the interaction of the microwave radiation with the first liquid-melt phase, both when it is present in the batch as a solid in this first melting phase and when it is present in liquid form.

In certain of the presently disclosed embodiments, in the zone between batch covering and primary melt, the combination of the heating with microwave radiation, in particular with electrical, ohmic heating, may lead to an overall smoothing of the extensive horizontal temperature gradients in the melting region and hence to a slower flow. Heat is taken off via the batch covering, this heat coming from the lower melt bath via convection of the melt.

The microwave booster generates heat directly in the zone where heat is taken off, and consequently, in respect of the heat taken off from the melt bath, acts to reduce or to smooth the vertical temperature gradient beneath the batch carpet.

To date, with incoupling of the microwave radiation in the context of conventional melting tanks, this radiation was not utilized so efficiently for the transformation of the batch present in solid form into the liquid-melt state, as there was no microwave radiation absorption directed onto the melting reaction zone formed between the batch covering and the molten glass.

It is advantageous if the batch covering covers the glass melt superficially such that the surface thereof is covered completely in the region of the irradiated microwave radiation or the part of the batch covering that covers the glass melt even in fact extends on the surface of the glass melt beyond the region in which the microwave radiation is irradiated, since in that case it is possible to ensure that the greatest part, more particularly more than 90%, of the irradiated microwave power is used for the transformation of the batch, initially present in solid form, into its liquid state, more particularly without coupling the microwave power into the melt surface adjacent to the batch covering.

A coherent batch covering is regarded as being a mutually abutting particulate accumulation, extended in the manner of a sheet, of supplied batch constituents, which floats lying on the melt and which covers, preferably opaquely, the surface of the melt, more particularly at least in the region of the irradiated microwave radiation. Opaque coverage in this context is deemed to be a coverage which is present so completely that the irradiated microwave radiation at any location where it is irradiated initially passes through batch constituents, before remaining fractions of this radiation, if there has yet been no complete absorption, especially in the region of the primary melt, more particularly in the melting reaction zone, impinges on the glass melt.

When the batch is charged, this batch covering may be formed like a carpet—batch carpet—lying on the liquid-melt glass, with the height and lateral extent thereof being determinable through the amount of batch supplied per unit time and also through the radiant power of the microwave radiation.

The size of the batch carpet which arises when the batch is supplied as a batch charge, and also the associated height and lateral extent of this carpet on the glass melt, may be controlled—given constant power of the supplied microwave radiation and also given constant energy supplied further to the glass melt, which may be supplied additionally, for example, by means of electrical ohmic heating—by the amount of batch supplied per unit time and can therefore be adjusted to particularly desired values. In the case of a throughput of, for example, 0.5 t/d, this amount of batch supplied is about 20.8 kg/h.

Because the gases emerging from the melt which forms in the melting reaction zone, to the greatest extent condense again by cooling on the batch carpet of the batch charge, and hence recondense, the amount of batch constituents supplied corresponds, in the case of a melting tank operated in accordance with the present disclosure, approximately to the final glass composition of the respective tank as well, since discharge of volatile constituents is greatly suppressed.

In the description hereinafter of preferred embodiments, further examples of this are elucidated in even more detail.

An advantageous feature is the calming of the convection by uniform heating, more particularly lateral uniform heating, by means of the supplied microwave radiation and the avoidance of rapid flow pathways from the batch to the tank outlet because of the slower flow. Advantages of the invention are an optimization of the melting reactions and a more homogeneous melt.

It is generally advantageous to bring about a temperature increase and hence an increase in the melt production rate precisely in the melting reaction zone between batch and primary melt, by depositing energy at the border between batch and primary melt by means of microwave radiation.

This may be achieved more particularly by incoupling of microwave radiation from the direction of the top furnace by means of microwave-emitting sources. The top furnace as such remains colder here than the glass melt; no combustion gas is used and there is therefore no release of CO₂ from a combustion.

A further advantage relative to a gas-fired top furnace is that as a result of this heating, the batch is colder in the upper region than in contact with the melt and therefore the gas which is released during melting of raw materials can be taken off very efficiently through the porous, gas-permeable, relatively cold batch covering. Further advantages are reduced batch dusting during melting, since the melting reaction does not take place in a space with high gas velocities, and reduction of evaporation of the highly volatile components directly from the batch covering, particularly borates in the case of borosilicate glasses.

With microwave heating, in contrast to the gas-fired surface, there is no vitrification of the batch covering and hence the gases liberated are able to escape—they are not incorporated into the melt and need not be driven out again in subsequent, energy-intensive refining steps. The volatile constituents which rise from the underside of the batch upward, such as B- or Cl-containing components, are able to recondense in the cool batch carpet, thus minimizing the fraction of substances given off to the environment or to the top furnace.

In the case of the embodiments presently disclosed, it has been possible to reduce the discharge of B- or Cl-containing components from the melt by more than 50%, especially if, in melting tanks with all-electric operation, the total energy supplied to the batch for transformation into a glass melt comprises microwave radiation.

The cold top side of the batch carpet prevents the reaction of the refining agent on this side; for the same reason there is essentially no decomposition of individual raw materials, such as nitrates or carbonates, for example. Furthermore, the cold top side of the batch in the case of borosilicate glasses produces the evaporation of borate, which is advantageous for the attainment of the target composition and the reduction of dusting.

The initial vesicularity of the microwave-heated primary melt is substantially lower than the initial vesicularity of a burner-heated batch melt. The gas load of the microwave-heated primary melt is substantially lower than the gas load of a burner-heated batch melt.

The kinetics of melting down are determined by the sand grain dissolution. As long as this process is still ongoing, bubbles continue to be generated. In the context of the present disclosure, the region in which during melting down there is still solid material, already molten glass, and the top furnace atmosphere, including for example gases emerging from the melt, and hence the region with solid, liquid and gaseous constituents, corresponds to the region of sand grain dissolution and is in contact with the glass melt flowing below it. As a result of this melting-down process it may even be possible in an ideal scenario to forgo secondary refining. A microwave-assisted, fully electrically operated melting tank supplies glass sufficiently good for numerous product requirements.

Using power with a neutral CO₂ balance, therefore, it is also possible to attain the goal of a “CO₂-free melting process”.

In conventional processes, at relatively high current density, and depending on the glass chemistry, it was possible for secondary effects to occur at the electrodes that resulted in the ingress of electrode material into the melt—intolerable for specialty glass—and that also limited the operating life of the electrodes. This ingress is distinguished by tiny particles—lying in the range—which in turn may cause great disruption, even as far complete production failure. The extent of the failure is heavily dependent on the specification of the glasses. Typical contamination levels with molybdenum electrodes have values in the 5 to 100 ppm range, with 30 ppm already being intolerable in certain applications. With certain specialty glasses, however, even contamination levels of >10 ppm have led to intolerable problems.

A further disadvantage of conventional tanks heated purely electrically by the ohmic resistance of the glass is also that the electrical heating with electrodes may be limited by excessive temperatures in the region of contact between the glass and the refractory material of the walls. A further advantage of the microwave radiation heating is that the electrical power can be introduced contactlessly in the region directly below the batch and therefore “far away from the refractory material of the walls” and accordingly this wall material can be considerably more resistant to long-term operation.

In contradistinction to the electrode heating, the colder temperatures below the batch covering directs the current in the case of ohmic heating into regions of warmer temperatures. This means that with purely ohmic heating, no energy enters directly below the batch zone. This serious disadvantage can be circumvented with the presently disclosed technical development relative to conventional melting.

The concept of the microwave or of microwave radiation that is used in the context of the present disclosure is initially, thus without further clarifying definition, a trivial name for electromagnetic waves having a frequency which in the older literature was reported as ranging from 1 to 300 GHz, corresponding to a wavelength of about 30 cm tol mm under reduced pressure. Other, more recent literature references report even wider limits of the frequency range—for example, from 300 MHz up to about 1 THz. In the context of the present disclosure, microwaves are understood by definition to be electromagnetic waves corresponding to more recent literature reports, having a frequency of 300 MHz to about 1 THz.

In the context of the present disclosure, the concepts of microwave radiation and of the microwave are used synonymously and in each case denote the same, above-defined electromagnetic waves.

In the manner conventional in the art, the batch refers to the constituents of the subsequently molten glass that are present in solid form before they have been charged to the glass melt, and the primary melt refers to the molten batch which has not yet been subjected to further refining, more particular advanced refining.

Illustratively and without restriction on the generality, the batch may comprise glass-ceramic and/or else BS glass types, more particularly borosilicate glass types, and cullet contents of 20% to 50%.

Primary melt is a technical term from glass technology and denotes the melt prior to refining. It is the first liquid-melt phase in which all of the raw materials have transitioned to the liquid state but are there are still bubbles present.

In the context of the present disclosure, the concept of melting, as a generic term, embraces the processes of melt production and of melting down.

Melt production is understood to be the process of the melting of at least parts of a batch body present in solid form, which in this case transitions from its solid physical state into a liquid physical state, as is described in more detail hereinafter and as is defined for the purposes of the present disclosure.

Melting down refers to the complete conversion of a batch body initially present in solid form into its liquid state, more particularly its conversion into the primary melt of the glass melt.

Generally speaking, it has proven advantageous if heating in the region of the batch charge is performed by means of the microwave radiation.

In this case it is possible to bring about an increase in the melt production rate even in tanks with ohmic electrical heating.

The melting reaction zone in the context of the present disclosure is a spatial border or transition region in which the batch on one side of this border is still in the form of a solid and on the other side of this border or transition region there is already melt production, or there are instances of melt production, and the batch in particular is undergoing transition into a liquid state. The initial liquid phases are formed by the melting salts, e.g., Na₂CO₃, B₂O₃, at their respective melting point, in which they reactively dissolve the other batch components.

There are a variety of chemical reactions involved in the development of a silicatic melt. The first reactions begin in the solid state between partners (e.g., alkali metal/alkaline earth metal carbonates such as Na₂CO₃, and SiO₂) when the temperatures for forming eutectic phases (e.g., Na₂O—SiO₂) are attained. Initial, low-melting alkali metal silicate compounds are formed. Concurrently with the transformation of the alkali metal and alkaline earth metal carbonates and/or hydroxides, gases are released, which can leave the process through the open batch covering. Through further temperature increase, low-melting raw materials attain their melting temperature. It is only the occurrence of a liquid phase that significantly raises the reaction rate. The system present at that point is referred to as the primary melt, containing melted alkali metal silicate compounds with residual quartz grains and other low-solubility components remaining. The residual quartz grains and the other low-solubility components dissolve gradually at higher temperatures with corresponding residence time in the silicatic melt already present, and the final glass composition is formed. When microwaves are used, they couple in as early as during the occurrence of the first eutectic phases, and accelerate the reactions, since the microwave radiation is absorbed by this alkali-rich and therefore highly conductive phase. The greater the extent to which residual quartz and the remaining low-solubility components dissolve in the primary melt, the less microwave energy is absorbed. In other words, the microwaves targetly assist the process of melting down, particularly in the initial liquid-melt phases.

The depth of the melting reaction zone is generally a few millimeters and, preferably according to type of glass, may extend over a range from about 1 mm to 100 mm in the direction of the microwave radiation.

Because the microwave radiation radiates into a volume, the melting reaction zone need not be located on the outside of the respective bodies of the batch, but instead, with increasing temperature, may also fully capture a respective batch constituent or batch body, present initially in solid form, particularly if this constituent or body undergoes an overall increase in its temperature and is therefore brought overall by heating initially from a temperature Tg−5K up to a temperature Tg+50K or more particularly to higher temperatures. In this case there need not be a sharp local border formed within a batch body; instead, the melting zone in that case is understood to be the entire location in the batch body which local regions thereof are at a temperature of Tg−5K and melts produced are at a temperature Tg+50K and, more particularly, higher temperatures. This case occurs in particular in a low-corpuscular or pulverulent batch with a size in the range of the size of the melting reaction zone.

The microwave radiation is preferably irradiated from the direction of the top furnace by microwave-emitting sources. Unlike thermal radiation, MW radiation is not diffuse, but may instead may be introduced in directed or partly directed form using suitable measures, such as protective FF walls. Directed rays are advantageous, generated for example through the use of Vivaldi antennas or trumpet radiators. Antennas in the top furnace direct the rays onto the tank or the surface of the batch.

The top furnace as such remains colder here than the glass melt; no combustion gas is used and therefore no CO₂ is released from a combustion.

In the case of the embodiments presently disclosed, at least 10% of the energy supplied to the batch for transformation into a glass melt preferably comprises microwave radiation.

The energy supplied for transformation into a glass melt is understood here to be the total energy used for heating the glass and supplied to the batch until the latter is in liquid-melt form, more particularly in the form of a primary melt, and hence the total energy used for heating before the batch undergoes initial or final refining.

The primary melt is heated overall up to a glass viscosity of less than or equal to 10³ dPas, but at least 10² dPas. Beyond this viscosity value, the molten glass, including in particular for relatively low viscosity values, is assumed in the context of the present disclosure to be present as a liquid melt or in liquid form.

In particularly preferred embodiments, however, the total energy supplied to the batch for transformation into a glass melt comprises microwave radiation.

An alternative possibility, more particularly for boosting the melt production performance or melting-down performance, is that wherein, additionally to an ohmic electrical heating of the melt, the irradiation of microwave energy takes place proceeding from a top furnace at which microwave-emitting sources, more particularly microwave radiators, are disposed, and preferably the microwave energy is irradiated into a zone between the batch and a primary melt for heating, more particularly for absorbing the microwave radiation.

With the presently disclosed embodiments it is possible to provide a CO₂-neutral method of melting down glass, wherein the input of energy in the melting zone takes place with a combination of electrical, more particularly ohmic, heating and microwave irradiation, and the electrical energy used for melting down is provided with electrical power which has an at least neutral CO₂ balance.

A CO₂-neutral method for melting down glass refers to a method in which the total amount of CO₂ present is not increased by the melting-down method.

A neutral CO₂ balance is regarded in the context of the present invention to correspond to generation of electrical power where the generation of the electrical power does not increase the amount of CO₂ present overall.

Power with neutral CO₂ balance is considered consequently to be power obtained through solar energy, wind power, water power and/or nuclear power.

Fuels obtained by biological processes as well, also referred to generically as biofuels, or substances obtained by chemical reactions, which are obtained with support, for example, from solar energy, such as, for example, in methanol recovery, the methanol also referred to as methanol solar fuel, are considered to have a neutral CO₂ balance when, during production and their subsequent utilization, they do not lead overall to an increase in the CO₂ fraction in the atmosphere. In the context of the present disclosure, such biofuels may be used for burners which have a neutral CO₂ balance and can also be used, for example, in the present method and in the presently described apparatus, in the refining area.

Methods presently disclosed, more particularly melting methods, are methods wherein the microwave radiation is incoupled in a region of a melting tank in which no top furnace firing by means of burners is performed.

A particularly advantageous aspect of the embodiments presently disclosed is that they require neither vacuum or reduced pressure for their realization and are also not reliant on cooled walls, as is required, for example, in the case of skull crucibles.

A further advantage attending the presently disclosed embodiments is also that they need not comprise a plurality of tanks necessarily coupled with one another, such as cascade tanks, for example, because, owing to the highly efficient incoupling of the microwave radiation, it is already possible for there to be complete transformation of the batch within a melting tank in the liquid-melt state of the batch beneath the batch carpet.

The generation of the microwave radiation may be performed by at least one magnetron and/or by at least one semiconductor-based generator of microwave radiation.

In the generation of the microwave radiation, in the case of the presently disclosed method and also with the presently disclosed apparatus, microwave radiation having a frequency of higher than 500 MHz and lower than 6 GHz is preferably provided.

In the case of the presently disclosed method and also with the presently disclosed apparatus, the microwave radiation may also be provided with a frequency of lower than 3 GHz, preferably lower than or equal to 2.45 GHz or lower than or equal to 915 MHz.

In the method presently disclosed, the throughput of the molten glass is more than 0.5 t/d or at least 0.5 t/d.

In the case of an apparatus of the invention for melting down glass, more particularly for transforming a batch into a glass melt, more particularly for implementing a method as is presently disclosed, the apparatus comprises a melting unit with a melting tank, which has walls within which both the batch for melting and the molten batch can be accommodated as a glass melt, where above the batch and above the glass melt there is at least one microwave-emitting source disposed, more particularly at least one microwave radiator.

The at least one microwave-emitting source is preferably disposed at a top furnace of the melting tank. This ensures an areal distribution of the microwave radiation over the batch carpet.

In the case of the embodiments of the presently disclosed apparatus, the microwave radiation from the microwave-emitting source is directed onto the melting reaction zone between batch and primary melt.

In the case of the presently disclosed apparatus, additionally, in further embodiments, a facility or two or more facilities for the ohmic electrical heating of the melt may be provided.

When microwave radiation is used on its own, without further energy input from other energy sources, for the melting—hence for the melt production and melting down of batch, especially in the context of the transformation of a batch into a glass melt, in the implementation of the method, the microwave radiation used may fully capture the entire melting reaction zone, hence including the entire three-dimensional volume of the melting reaction zone.

Alternatively this may also be the case if further energy sources are provided for the heating, for the melting operation; in that case, however, this need not automatically be the case.

Where further energy sources are provided for the heating, examples being ohmic electrical energy sources, for the melting operation, the local region captured by microwave radiation may also be up to about 10% or less of the locally captured three-dimensional volume of the melting reaction zone, or it may alternatively be 20%, 40% or 60% of the locally captured three-dimensional volume of the melting reaction zone.

In that case, moreover, by means of a targeted local input of energy by means of the microwave radiation, it is also possible to establish a defined flow regime by, for example, introducing locally confined temperature inhomogeneities, also including, in particular, microturbulences through local gas release/bubbles, at local positions which are advantageous for the melting operation, and these inhomogeneities/microturbulences may already provide preparatory assistance for a subsequent refining operation.

In the case of the preferred embodiments, however, the at least one source for emitting microwave radiation is coupled in in a region of a melting tank in which no top furnace firing by means of burners is performed or in which no burners for top furnace firing are disposed.

### BRIEF DESCRIPTION OF THE DRAWINGS

The invention is described in more detail below with preferred embodiments and with reference to the appended drawings, in which

FIG. 1 shows a comparison of the electrical conductivities of various glasses as a function of the temperature of the respective glass,

FIG. 2 shows tan(delta), describing the incoupling of the microwave into glasses, and measured for certain typical specialty glasses, with tan(delta) values for different glasses being represented as a function of the temperature indicated in ° C.,

FIG. 3 shows both the penetration depth D in μm and the irradiated power input P in W/cm³ at E=10 kV/m as a function of the temperature indicated in ° C. for glass A,

FIG. 4 shows both the penetration depth D in μm and the irradiated power input P in W/cm³ at E=10 kV/m as a function of the temperature indicated in ° C. for glass B,

FIG. 5 shows tan(delta) and the dielectric constant for different powder sizes as a function of the temperature indicated in ° C.,

FIG. 6 shows the swelling term p determined within a simulation (FlexPDE simulation) for an illustrative glass, determined on a layer thickness of 4 mm in x-direction of 20 MW/m³ as dropping close to 0,

FIG. 7 shows an apparatus for melting down glass, more particularly for transforming a batch into a glass melt, in a first preferred embodiment,

FIG. 8 shows an apparatus for melting down glass, more particularly for transforming a batch into a glass melt, in a second preferred embodiment, and also a vertical temperature profile Tmw resulting in this apparatus, in comparison to the vertical temperature profile Th of a conventional melting tank without top furnace heating and to the temperature profile Tob of a conventional melting tank with top furnace heating.

### DETAILED DESCRIPTION

In the description which follows, identical reference symbols in the figures denote in each case identical or equivalent constituents or functional elements. For the sake of better understanding, however, the figures are not represented to scale, unless the representation is a diagrammatic two-dimensional representation of respective data quantities.

While all of the methods described before in the prior art utilize microwave radiation as a heating method in the volume, it has not been recognized that the temperature-dependent and material-dependent absorption behavior of microwave radiation can be utilized in order to pass microwave radiation, as virtually absorbing-free radiation, through cold regions of the batch cover, this absorption, as soon as it impinges on a hot glass melt, then being fully absorbed in a very short zone and converted into thermal energy.

This zone may be, for example, the melting reaction zone described in the context of the present disclosure.

This effect of temperature-dependent absorption is recognized as a problem in numerous specifications, and is described with the associated formation of hotspots. To date, however, it has not been recognized that this effect, hitherto regarded to be deleterious and detrimental, may be utilized in the area of the melting-down of batches.

No specification in the prior art has to date described how, as in the presently claimed method, the glass melt is melted continuously and the microwave heating, i.e., the microwave radiation used for heating, serves for or essentially only for melt production from the batch of the interface with the hot glass melt, also referred to essentially below as melting reaction zone, and is directed onto this zone between batch and primary melt.

Advantageously, moreover, the microwave in the melting-down region of a melt heated electrically below the batch may be employed as heating from “above”.

This means that in certain presently disclosed embodiments, the microwave radiation is able to replace the top furnace burner firing that is customary in industrial tanks.

With the presently disclosed embodiments, therefore, it is possible to circumvent a disadvantage to date of melting tanks with all-electric heating, also referred to as AE tanks, in terms of quality, throughput limitation and flow instability, owing to the vertical temperature gradients.

The invention advantageously also exploits the incoupling behavior of microwave radiation, hence of the microwave energy incoupled by absorption into glass melts, which in the case of conventional microwave applications leads to the negative and unwanted effect of formation of hotspots.

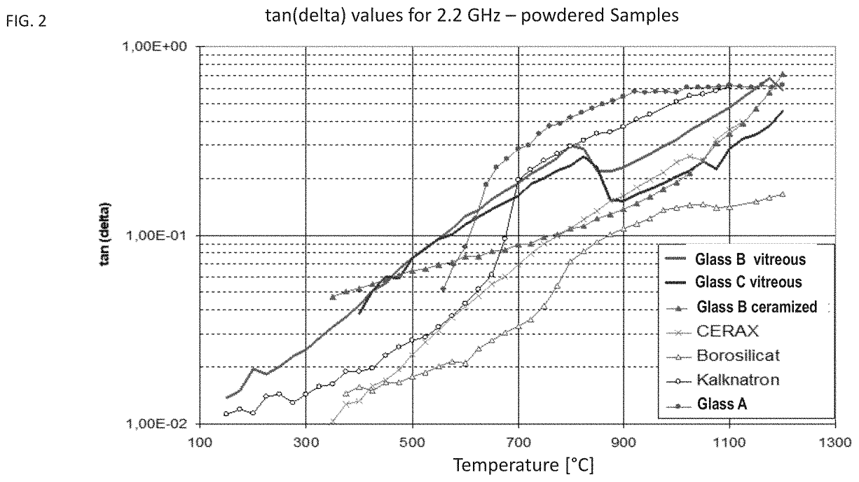

Indeed, as described in more detail below with reference in particular to FIGS. 2 to 8, the microwave radiation couples into the material to only a very low extent in the batch carpet at low batch temperatures. This means that the material in this temperature range is transparent or semitransparent to microwave radiation and hence exhibits only low absorption for such radiation.

When the microwave radiation has penetrated the batch, this radiation impinges on the first zone of the hot primary melt that lies in its path. There, the microwave absorption increases sharply and the entire energy is absorbed and converted into thermal energy in a very short section of a few millimeters or centimeters—depending on glass synthesis—substantially in this zone, which is presently also referred to as melting reaction zone, between batch and melt surface of the primary melt.

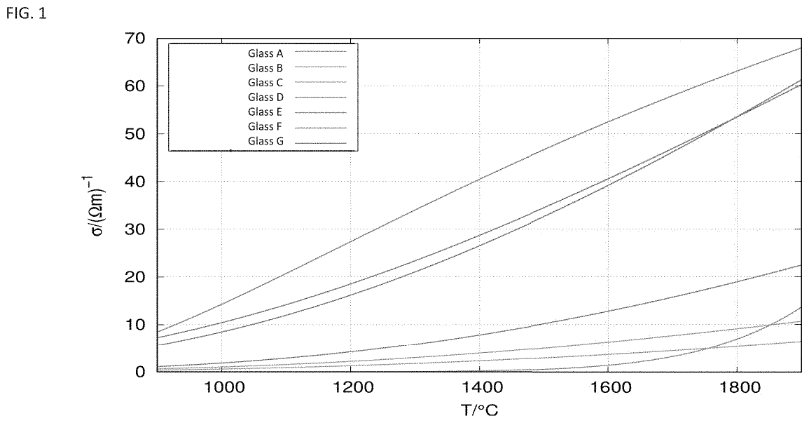

FIG. 1 shows a comparison of the electrical conductivities as a function of the temperature for different glasses. Here, and also in the further course of the presently disclosure, glass A denotes an alkali-free glass, glasses B, C and D denote borosilicate glasses with different boron contents, and glasses E, F and G denote different alumosilicate glasses.

The coupling of the microwave into glasses may be described by tan(delta), which is proportional to the absorption of the microwave radiation, more particularly its irradiated power, and has been measured for certain typical specialty glasses, and is also represented in the graph of FIG. 2. Delta here denotes the loss angle, which indicates the angle between the complex dielectric constant and its real component. The resultant penetration depths of the microwave field of the microwave radiation are calculated by way of example below for two glasses. The penetration depth of the microwave energy into a material is described here by D, a quantity which indicates the distance within the power has dropped to 1/e relative to the value at the surface of the material on which the microwave radiation impinges.

At temperatures below 400° C., the penetration depth D according to type of glass is in the 0.1 m to 1 m range—in other words, the microwaves presently described radiate with decidedly little attenuation through a cold batch/raw material mixture.

In the region of the melting temperature of the glasses, the penetration depth is a few centimeters—in other words, at typical melting bath depths of 50-100 cm, there is complete adsorption, and conversion to thermal energy, in the upper melt region below the batch covering.

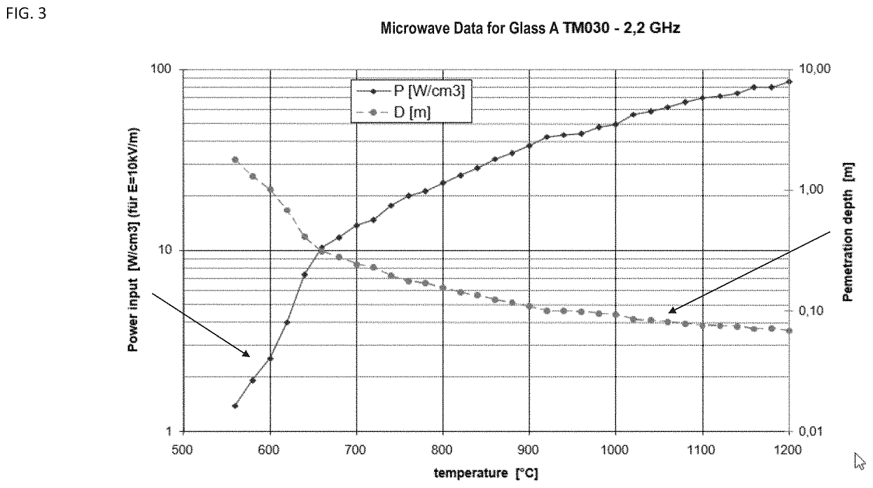

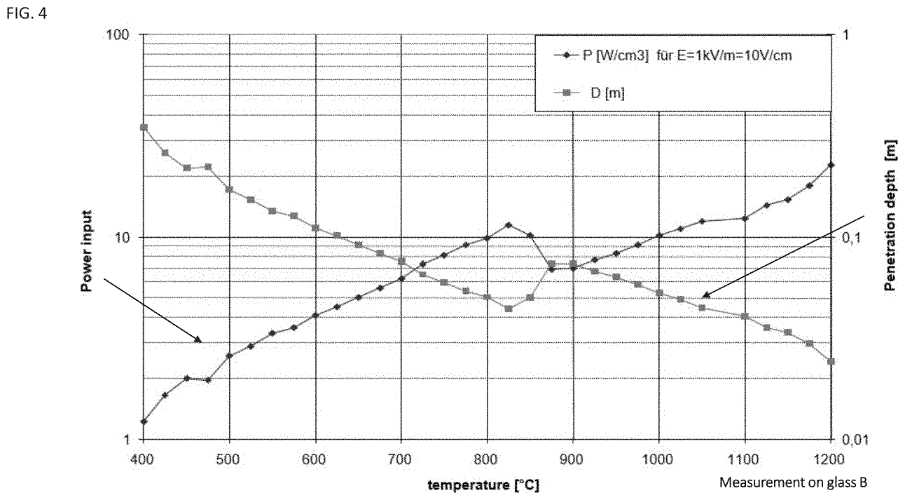

In this regard, see also FIG. 3 and FIG. 4, for example, which respectively show, as indicated in these figures, the penetration depth D in m and also the irradiated power density P (power input) in W/cm³ at E=10 KV/m as a function of the temperature indicated in ° C.

FIG. 3 describes the behavior for glass A and FIG. 4 for the glass B material. The glass material may for example be a composition which can be transformed into a glass-ceramic.

This heat is generated preferably in the hot zone facing the melt, more particularly in the melting reaction zone, where it leads at least to an acceleration of melting down or even to the entire melt production and/or melting-down process.

Another factor on which the microwave absorption is dependent is therefore that of whether the material is a solid body or in powder form. The present measurements have shown that pulverulent bodies or particles, presently having a mean diameter of less than 50 μm, exhibit volume-based absorption or incoupling that is lower by a factor of 3 than solid bodies or particles which presently had for instance a mean diameter of several mm, owing to the relatively loose fill and the volume factor. This effect helps here to locate the energy exactly at the correct point—that is, not in the relatively loose batch region of the batch covering, but instead only in the liquefying or liquid compact phase of the melting reaction zone. Advantageous process parameters are the bulk density of the batch and the bubble fraction of the melting batch.

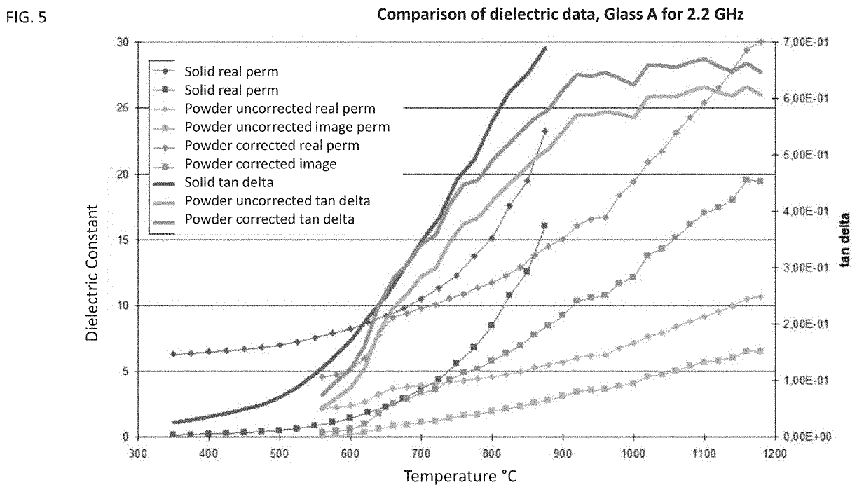

The temperature behavior of the dielectric parameters, typical for glasses, is also readily apparent from the powder measurements shown in FIG. 5. The real and imaginary components of the dielectric constant may each be determined experimentally for a given frequency and a particular material, and so the penetration depth D can be calculated from them. These values are dependent not only on the composition of the batch or glass, but also on the temperature and the degree of transformation of the batch into glass. If the penetration depth is low relative to the dimensions of a batch body or batch particle, only an outer zone can be directly heated with the

MW radiation. The situation is different if the penetration depth is large in comparison to the dimensions of the batch body. In that case, only a small part of the MW energy is absorbed in the body or particles; the remainder passes through the batch body in the same way as visible light through a transparent glass.

In this case, in FIG. 5, the designations “solid Real Perm” indicate in each case the real component of the dielectric constant in accordance with the standard DKE-IEV 121-12-13 for solid bodies, and “solid Imag Perm” indicate in each case the imaginary component of the dielectric constant in accordance with the standard DKE-IEV 121-12-13 for solid bodies. The designation “solid tan d” indicates the value of tan(delta), determined from imaginary component and real component, for the corresponding solid bodies. The value of tan(delta) results from the ratio of the imaginary component relative to the real component of the respectively measured dielectric constants.

The microwave radiation is preferably coupled into a mixture of glass raw materials having a particle size, and thus a maximum lateral extent, in the 10 μm to 500 μm range, in which case this batch initially forms relatively low-melting primary phases, in which the higher-melting raw material grains are then dissolved. Alternatively or additionally, the batch may also be admixed with cullet having a larger lateral extent of up to a few mm.

Up to Tg (glass transition temperature), there is a steady increase in the dielectric losses. In the region of Tg, a very sharp rise in the losses is observed, since here the bonds become “loosened” and the mobility of the ions becomes substantially greater. For the use of microwave, the “hotspot effect” levels out in the region of the batch zone, since, while the glass does tend to form hotspots during melting, when it is softened, the absorption nevertheless losses its heavy dependency on temperature and the thermal runaway effect becomes intrinsically more mild.

The effective conductivity or the imaginary component of the relative permittivity is composed, as set out comprehensively in textbooks, of two fractions.

At high temperatures of around >1400° C., the ohmic fraction is predominant, and for typical glass melts has still not reached saturation even at 2000° C.

σ=20 S/mω∈₀∈″ᵣ=0.14 S/m∈″ᵣ=1Example:

σ=20 S/mω∈₀∈″ᵣ=0.14 S/m∈″ᵣ=1 at 2.45 GHz and

In this region, however, the absorption by electrical conductivity then comes to the fore, and ensures complete absorption of the microwave radiation within a few millimeters. See, for example, FIG. 1 and also the description thereof above.

From the representation in FIG. 1 it is apparent that the ohmic conductivity does not tend toward a limiting value. In order to prevent local overheating, however, a control of the microwave radiation power may also be advantageous for the glass melts, as in this case the penetration depth is likewise reduced.

In the region of the transition to the primary melt, on the basis of the characteristic data, power inputs of 10 to 100 W/cm³ (10 W/cm³=10 000 000 W/m³=10 000 kW/m³) in the case of the presently described versions of the method and in particular with the presently disclosed apparatus are readily possible in each case.

In this case, the power is absorbed at a depth of the melting reaction zone of a few millimeters. An example in this regard is indicated below.

Assumption: 50 000 kW/m³*0.1 m=5000 kW/m² for E=10 kV/m.

By way of example:

ν=2.45 GHz

∈′ᵣ=4 and ∈″ᵣ=0

σ=43 S/m

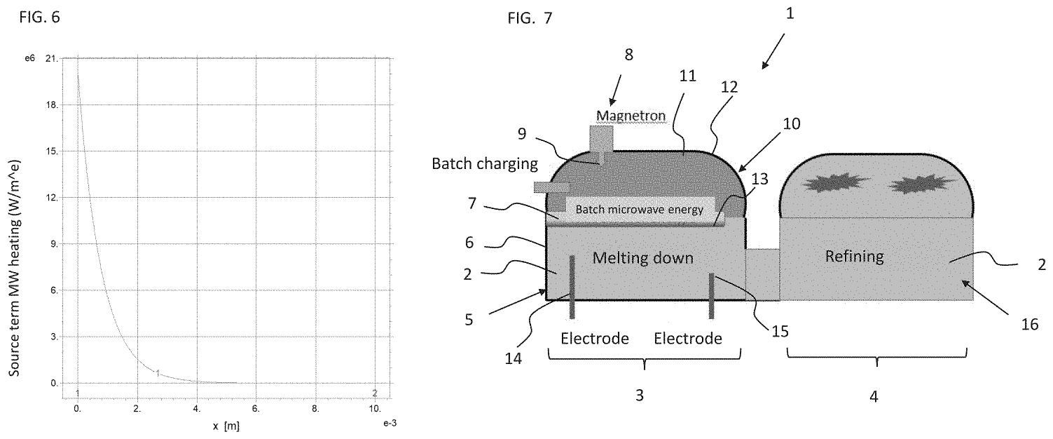

at a simulating field strength E=967 V/m, corresponding to an intensity of 1241 W/m² (in air); in this regard, see also FIG. 6.

According to the representation from FIG. 6, as part of a simulation, the source term p (FlexPDE simulation), which indicates the calculated power absorbed in each case per unit volume W/m³, is determined on a layer thickness of 4 mm in x-direction of 20 MW/m³ as dropping to nearly 0 and is represented correspondingly therein.

From this it is also apparent that in a thin layer, such as a layer 4 mm in thickness mentioned above by way of example, the power densities deposited are already very high and almost complete—this means up to more than 90% of the energy of irradiated microwave radiation can be absorbed and provided as energy for heating.

Preferred temperatures for the incoupling of the microwave radiation are in the range from 50° C. to >1400° C.

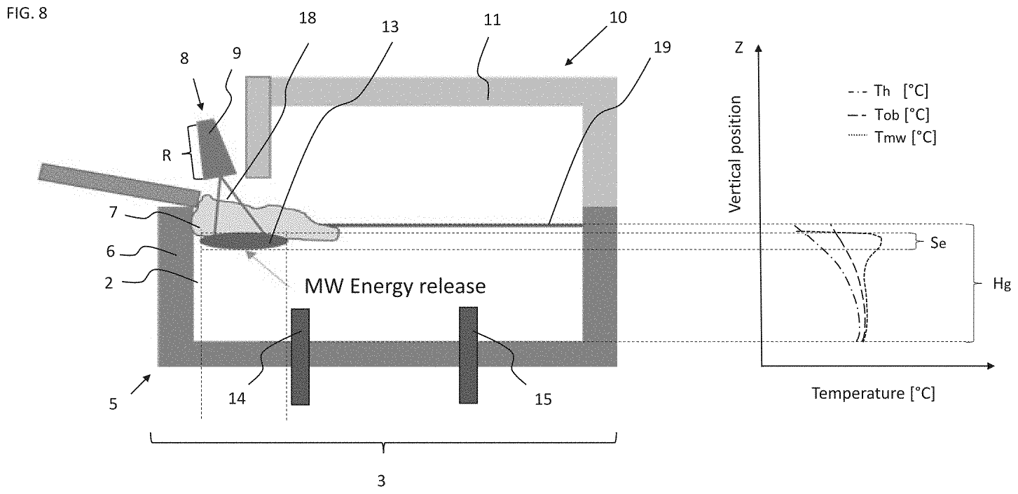

Embodiments of the apparatuses are described below, with reference FIGS. 8 and 9.

First exemplary embodiment of the melting unit

Reference is made below to FIG. 7, which shows—provided overall with the reference numeral 1—an apparatus for melting down glass, more particularly for transforming a batch into a glass melt.

This apparatus, as seen in the flow direction of the molten glass 2, comprises a melting unit 3 and a refining unit 4.

Even if not explicitly represented above, the melting unit 3 comprises all of the supply facilities needed for the melting of glass, including, in particular, electrical supply facilities, which are able to supply electrical power with a neutral CO₂ balance.

This apparatus 1 is suitable for implementing the presently described methods, more particularly for implementing the method of the invention.

The melting unit 3 comprises a melting tank 5, which has walls 6 consisting of refractory material, within which both the batch 7 for melting and the molten batch in the form of molten glass 2 and hence glass melt 2 is accommodated.

In the region of the melting unit 3, the glass is present in each case as batch 7 in solid form or, after melt production therefrom, in a form which is becoming liquid, going into the glass melt 2, and is liquid.

Above the batch 7 and also above the glass melt 2, which extends from the bottom of the melting tank 5 up to a height Hg in liquid-melt form in the melting tank 5, there is at least one microwave-emitting source 8 disposed, more particularly at least one microwave radiator 9, which comprises a magnetron or a semiconductor-based generator of microwave radiation.

The region above the glass melt 2, which forms the roof dome 10 of the melting tank 5, is termed the top furnace 11.

The microwave irradiation is irradiated as described above such that it is absorbed in the melting region zone 13, meaning that it is coupled into this zone and leads as a result to the heating of said zone.

As is evident from FIG. 7, the melting reaction zone 13 is disposed directly below the batch covering 17 formed by the charging of the batch 7, and extends in a vertical direction between the glass melt 2 and the batch 7 still present as a solid.

The vertical direction is understood to be the Z-direction indicated in FIG. 8, which extends upward perpendicularly to a horizontal plane, this being, for example, the surface of an uncovered, flow-free glass melt 2. It is relative to this vertical direction that, in the context of this disclosure, the designations “above” or “beneath” and also “over” or “below” are based, insofar as these are spatial indications.

The closer particles of the batch 7 to the glass melt 2, the higher their temperature and also the higher the absorption capacity proportional to tan(delta), as evident from FIG. 5 from the associated description. This then results in a negative vertical direction, essentially, in the penetration depths D, which can be seen in FIGS. 3 and 4, for the respective temperature of particles of the batch 7.

It is apparent that with increasing temperature of the batch 7, there is a sharp decrease in the penetration depth D of the microwave radiation 18, which as shown in FIG. 8 takes place in the negative Z-direction such that the microwave radiation 18 of the microwave-emitting source 8 deposits very high power densities even in the region of 4 mm thickness, and is absorbed almost completely, meaning up to 90% of the energy of irradiated microwave radiation, and is provided as energy for the heating in particular of the particles of the batch 7. The microwave radiation energy is converted exactly in the region where it is needed for a high specific melting performance, in the melting reaction zone 13. The melt 2 becomes significantly hotter almost only in this zone, as a result of the microwave radiation, and the processes of melting down are able to operate much more quickly in the reaction zone, without a marked increase in the temperature of the melt 2 as a whole. The higher levels of melt production can be achieved without a marked temperature increase of the melt volume as a whole, meaning that the corrosion of the walls 5 and the electrodes 14 is not increased.

The microwave radiation is generated in this case, for example, by one or more magnetrons (915 MHz and/or 2.45 GHz) which are disposed in the top furnace 11.

The top furnace 11 consists of ceramic material with low microwave absorption, e.g., SiO₂, or comprises such material, and is surrounded by a microwave-shielding metallic casing 12.

The batch 7 is charged via screw chargers known to the skilled person or through a “microwave-impervious” opening, designed in each case such that they cannot give off any microwave energy to the outside.

The power may be irradiated by one or more magnetrons. Heating with gyrotrons and magnetrons and also other microwave frequencies would also be possible in principle.

The charging duct may be considered as a waveguide, the sizing of which may be such that for the MW frequency employed it is operated at well below its cut-off frequency, taking account of the batch dielectricity. Accordingly there is no possibility of wave propagation, and waves which want to run outward from the region above the glass melt are attenuated exponentially in said region.

In the lower region, the melting tank 5 may be heated by an electrical ancillary heater (EZH), which possesses electrode 14 and 15, providing electrical power for the ohmic electric heating of the melt 2. The EZH may be operated, for example, at 50 Hz or 10 kHz.

Possible electrode materials of the electrodes 14 and 15 are all commonly used materials such as platinum, tungsten, molybdenum, iridium or tin oxide.

After melting down, the molten glass 2 is transferred into a refining region 16 of the refining unit 4 and is then transferred for shaping.

The energy input in the melting tank 5 takes place preferably only by way of electrical resistance heating and microwave energy.

Suitable microwave frequencies are preferably 915 MHz, although 2.45 GHz or 5.8 GHz are also possible. In this frequency range, magnetrons in power ranges up to 100 kW are available on a standard basis.

Examples of power inputs are as follows:

| | Through- | | Load per | Mt | LT | Micro- |
|---|---|---|---|---|---|---|
| | put | | unit area | EZH | [kW] | wave |
| Example 1 | [t/d] | Area | [t/m2] | [kW] | power/gas | [kW] |
| 1.1 VE | 20 | | 2 | 1200 | 200/900 | |
| 1.2 VE + | 30 | | 3 | 1000 | 200/900 | 300 |
| microwave | | | | | | |
| 1.3 VE + | 20 | | 2 | 800 | 200/— | 200 |
| microwave | | | | | | |

In the table above, the designation AE denotes all-electrically operated tank with ohmic electrical heating, and AE+microwave denotes all-electrically operated tank with ohmic electrical heating and microwave radiation. Microwave [kW] denotes the irradiated microwave power in kW, MT EZH [kW] the electrical power of the electrical ancillary heating in kW,

The gas consumption reported in the table above is essentially the gas consumption in the refining tank area, for which it is also possible alternatively to use biofuel.

In the case of the power inputs of the melting tank referred to above in 1.3, a batch carpet of the batch 7 lying on the glass melt is formed in the case of the all-electrically operated melting tank 5 (hence a melting tank operated without the input of nonelectric power or energy) at, for example, a throughput of 20 t/d, with an ohmic power for the heating of the glass melt of 800 kW and with a microwave power, irradiated from above into the batch 7 of the batch carpet of 200 kW. In this case the melting tank is operated with a load per unit area of 2 t/m², meaning that the weight of the glass 2 and of the batch 7 acting on the base of the melting tank in said tank amounts, per unit area, to about 2 t/m².

In the case of the further all-electrically operated melting tank 1.2, it was possible to provide a batch carpet of the batch 7 lying on the glass melt at, for example, a throughput of 30 t/d, with an ohmic power for the heating of the glass melt of 1000 kW and with a microwave power, irradiated from above, into the batch of the batch carpet, of 300 kW, the batch carpet provided being likewise a corresponding batch carpet lying on the glass melt. In this case the melting tank was operated with a load per unit area of about 3 t/m², meaning that the weight acting on the bottom of the melting tank in said tank amounted, per unit area, to about 3 t/m².

In this context, the microwave radiation 18 was incoupled in each case such that it captured only the batch carpet itself and also the melting reaction zone located below said carpet, but not the further surface of the glass melt lying exposed next to the batch carpet.

In further embodiments (FIG. 8), the microwave radiation 18 may also capture only half or a third of the area with which the batch covering or the batch carpet 13 extends flatly, more particularly opaquely on the glass melt 2. In this case the flat region considered as being captured for the microwave radiation is the region up to which the intensity of the microwave radiation has dropped from its maximum to a value of 1/e, where 1/e in the context of the present disclosure denotes in each case the reciprocal of Euler's number e.

Represented in FIG. 8, in its right-hand half in the Z-direction, is the vertical profile of the temperature Tmw, which results in this apparatus, in the glass 2 and in the batch 7, in respect of which it is apparent that the temperature Tmw initially increases at the level of the electrodes 14 and 15, upwardly starting from the bottom of the melting tank 5, but then decreases slightly as the height goes up and increases slightly again before the melting reaction zone 13, before then transitioning to a sharply pronounced maximum in the melting reaction zone 3, which extends approximately over the entire melting reaction zone 13 and hence over a distance Se in the Z-direction that corresponds approximately to the penetration depth D of the microwave radiation 18 irradiated from above.

It is also readily apparent, in this case from a temperature profile Tmw coming from above, that the batch initially present at a low temperature is very greatly increased in its temperature Tmw over a very short distance, with the maximum of the temperature Tmw lying within the region Se of the melting reaction zone 13.

Shown in comparison to the profile described above as well, illustratively, is the vertical profile of the temperature Th from a conventional melting tank without top furnace heating, and the profile of the temperature Tob from a conventional melting tank with top furnace heating.

In these greatly simplified representations it is apparent that in the case of the embodiments presently disclosed, relative both to the conventional melting tank without top furnace heating and to a conventional melting tank with top furnace heating, increases less sharply toward the surface 19 of the molten glass 2 and hence in the glass melt 2 as well there is a more homogeneous vertical temperature distribution. In the above representation of the respective temperature profiles, on indication of the profile of the temperature Tmw, at least 10% of the energy supplied to the batch for transformation into a glass melt comprised microwave radiation.

Exemplary embodiment of a microwave radiator. In this exemplary embodiment, for the microwave radiator 9, more particularly the magnetron or the semiconductor-based generator of microwave radiation, a trumpet radiator is used, of the kind configured for example as a horn antenna and described in Kraus, J. D. Antennas, McGraw-Hill; see, for example, https://archive.org/details/Antennas2ndbyjohnD.Kraus1988/page/n677.

The emission characteristic required determines the construction length R and also the length of the side faces of the antenna of the microwave-emitting source 8.

In order in the future to enable CO₂-neutral melting processes, there is a general advantage to switches from heating with hydrocarbon combustion to electrical heating systems, and in this case more particularly with the use of electrical power from renewable energy. Replacement of the burner technology by electrically heated radiators, however, has failed especially in the melting-down area because at present there is no material which has long-term operation robustness under the conditions prevailing there, hence at high temperatures with severe dusting. This technical problem, however, has been solved with the above-described methods and apparatuses, since, because the region in which heat is required for melting, more particularly for the production of melt from the batch and for the further melting down of the batch to form a primary melt, as a result of the arrangement of the microwave-emitting source, more particularly magnetrons or semiconductor-based generators of microwave radiation, and the defined local delivery of microwave radiation, which through absorption, in a locally defined way, couples in heat to the batch and also melt produced from the batch, and to a part of the primary melt, it is possible to maintain a defined distance from the walls, more particularly walls consisting of refractory material, of the melting tank.

The apparatuses described above are more robust in long-term operation than when using burners, since the location at which the microwave-emitting source, more particularly magnetron or semiconductor-based generator of microwave radiation, is disposed, in particular the top furnace of the melting tank, does not have to be heated when microwave radiation is delivered.

Further field-homogenizing and therefore temperature homogenizing measures may be that the MW frequency is not fixed, but is instead “modulated through” from the microwave source, or that a mode stirrer is positioned above the melt to homogenize the field distribution, or that a stirrer is positioned in the batch and ensures a homogenization of the MW field and at the same time homogenizes the temperature in the batch.

Furthermore, through targeted release of energy in the glass-forming zone beneath the batch carpet, when using relatively little to no top furnace heating in the melting-down region, it is possible to reduce significantly the emission of volatile constituents, such as, for example, alkali metal borate, boron, fluorine, Cl, etc. The result is a cold-top-style evaporation-condensation circuit in the batch.

### LIST OF REFERENCE SYMBOLS

1 Apparatus for melting down glass
2 Molten glass, more particularly glass melt
3 Melting unit
4 Refining unit
5 Melting tank
6 Walls of melting tank 5
7 Batch
8 Microwave-emitting source, more particularly magnetron or semiconductor-based generator of microwave radiation
9 Microwave radiator
10 Roof or dome of melting tank 5
11 Top furnace of melting tank 5
12 Microwave-shielding metallic casing
13 Melting reaction zone
14 Electrode
15 Electrode
16 Refining region
17 Batch covering
18 Microwave radiation, more particularly from a magnetron or semiconductor-based generator of microwave radiation
19 Surface of molten glass 2, more particularly of glass melt 2
Hg Height of the surface 19 of molten glass 2
Th Temperature within the glass melt 2 in a conventional melting tank without top furnace heating
Tob Temperature within the glass melt 2 in a conventional melting tank with top furnace heating
Tmw Temperature within the glass melt 2 in one of the presently disclosed embodiments
Se Temperature profile in the region of the melting reaction zone 13

What is claimed is:

1. A method for melting down glass, comprising:
forming a glass melt using microwave radiation as at least part of an energy supply, wherein the forming step comprises:
irradiating the microwave radiation at a transition between a batch and a primary melt; and
coupling the microwave radiation into an upper region directly below a batch covering so that a temperature is increased.

2. The method of claim 1, further comprising supplying a batch charge to the glass melt to form a coherent batch covering lying on the glass melt.

3. The method of claim 1, wherein the batch covering covers the glass melt superficially such that a surface of the glass melt is covered completely in a region where the microwave radiation is irradiated.

4. The method of claim 1, wherein the batch covering has a part that covers the glass melt and extends on a surface of the glass melt beyond a region where the microwave radiation is irradiated.

5. The method of claim 1, wherein the step of irradiating the microwave radiation comprises irradiating from a direction of a top furnace by microwave-emitting sources.

6. The method of claim 1, wherein the microwave radiation comprises at least 10% of energy supplied to transform the batch into the glass melt.

7. The method of claim 6, wherein the microwave radiation comprises all of the energy supplied to transform the batch into the glass melt.

8. The method of claim 1, further comprising heating the glass melt with an ohmic electrical heating.

9. The method of claim 8, wherein the step of heating the glass melt with the ohmic electrical heating comprises using electrical energy that has an at least neutral CO₂ balance.

10. The method of claim 1, wherein the step of irradiating the microwave radiation comprises coupling in the microwave radiation in a region of a melting tank in which no top furnace firing by burners is performed.

11. The method of claim 1, wherein the step of irradiating the microwave radiation comprises generating the microwave radiation by device selected from a group consisting of a magnetron, a semiconductor-based generator of microwave radiation, and combinations thereof.

12. The method of claim 1, wherein the step of irradiating the microwave radiation comprises generating the microwave radiation with a frequency of higher than 500 MHz and lower than 6 GHz.

13. The method of claim 12, wherein the frequency is lower than or equal to 915 MHz.

14. The method of claim 1, further comprising generating a throughput of the molten glass is more than 0.5 t/d.

15. An apparatus for melting down glass, comprising:
a melting assembly having a melting tank which has walls within which both a batch for melting and a molten batch can be accommodated as a glass melt; and
a microwave-emitting source disposed above the batch and above the glass melt.

16. The apparatus of claim 15, wherein the microwave-emitting source is disposed at a top furnace of the melting assembly.

17. The apparatus of claim 16, wherein the microwave-emitting source is coupled into a region of the melting tank that is free from top furnace firing by burners.

18. The apparatus of claim 15, wherein the microwave-emitting source is positioned and configured to radiate microwave radiation onto a melting reaction zone between the batch and a primary melt.

19. The apparatus of claim 15, further comprising an ohmic electrical heater positioned and configured to heat the glass melt.

20. The apparatus of claim 15, wherein the microwave-emitting source is selected from a group consisting of a magnetron, a semiconductor-based generator of microwave radiation, a microwave generator generating the microwave radiation with a frequency of higher than 500 MHz and lower than 6 GHz, a microwave generator generating the microwave radiation with a frequency of higher than 500 MHz and lower than 3 GHz, a microwave generator generating the microwave radiation with a frequency of higher than 500 MHz and lower than 2.45 GHz, and a microwave generator generating the microwave radiation with a frequency of higher than 500 MHz and lower than or equal to 915 MHz.
